(19) United States
(12) Patent Application Publication
(10) Pub. No.: US 2012/0092717 A1
(43) Pub. Date: Apr. 19, 2012

(54) PRINT SERVER, CONTROL METHOD, AND PRINT SYSTEM

(75) Inventors: Takashi Saitoh, Tokyo-to (JP); Yutaka Tamada, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/274,440

(22) Filed: Oct. 17, 2011

Related U.S. Application Data
(60) Provisional application No. 61/394,527, filed on Oct. 19, 2010.
(60) Provisional application No. 61/467,625, filed on Mar. 25, 2011.

(51) Int. Cl. G06K 15/02

(52) U.S. Cl. 358/1.15

(57) ABSTRACT

According to one embodiment, a print server that is connected with at least one printing device and client terminal through a communication line, includes an information acquiring-storing unit configured to acquire and stores print data and attribute information of a print job from the client terminal, an information changing unit configured to shorten a portion of character strings of the attribute information of the print job on the basis of a preset changing rule, and an information transmitting unit configured to transmit the attribute information of the print job including some shortened information to the printing device in accordance with a request from the printing device.

### CROSS-REFERENCE TO RELATED APPLICATIONS

This application is based upon and claims the benefit of U.S. Provisional Applications No. 61/394,527, filed on Oct. 19, 2010; and No. 61/467,625, filed on Mar. 25, 2011.

### FIELD

Embodiments described herein relate generally to a print server, a control method, and print system.

### BACKGROUND

In a temporary storage print system, when a PC (Personal Computer) that is a client device transmits a print job to perform printing, the print job is not immediately performed, but stored temporarily in a server. A user displays the list of stored documents, using an MFP (Multi-Function Peripheral) that is a printer. The user selects a document to be printed on the basis of the display, thereby performing printing.

However, in a display device mounted in the MFP, the number of characters is limited in comparison to a display device mounted in the PC. Accordingly, the document names may not be entirely displayed in the document list display described above. In this case, problems are generated, such as that the user may not determine which document should be selected or that a document with a similar name is selected and printed.

### BRIEF DESCRIPTION OF THE DRAWINGS

FIG. 1 is an exemplary view showing the configuration of a print system according to a first embodiment.

FIG. 2 is an exemplary flowchart showing the order of registering print jobs in the print system according to the first embodiment.

FIG. 3 is an exemplary flowchart showing the order of printing in the print system according to the first embodiment.

FIG. 4 is an exemplary print job selection screen in the print system according to the first embodiment.

FIG. 5 is an exemplary character string setting file in the print system according to the first embodiment.

FIG. 6 is an exemplary flowchart showing the order of process changing a long document name in the print system according to the first embodiment.

FIG. 7 is an exemplary print job selection screen in the print system according to the first embodiment.

FIG. 8 is an exemplary print job selection screen in a print system according to a second embodiment.

FIG. 9 is an exemplary character string replace setting file in the print system according to the second embodiment.

FIG. 10 is an exemplary print job selection screen in the print system according to the second embodiment.

FIG. 11 is an exemplary list showing the functions of a print system according to another embodiment.

### DETAILED DESCRIPTION

In general, according to one embodiment, a print server that is connected with at least one printing device and client terminal through a communication line, the print server includes an information acquiring-storing unit configured to acquire and stores print data and attribute information of a print job from the client terminal, an information changing unit configured to shorten a portion of character strings of the attribute information of the print job on the basis of a preset changing rule, and an information transmitting unit configured to transmit the attribute information of the print job including some shortened information to the printing device in accordance with a request from the printing device.

### First Embodiment

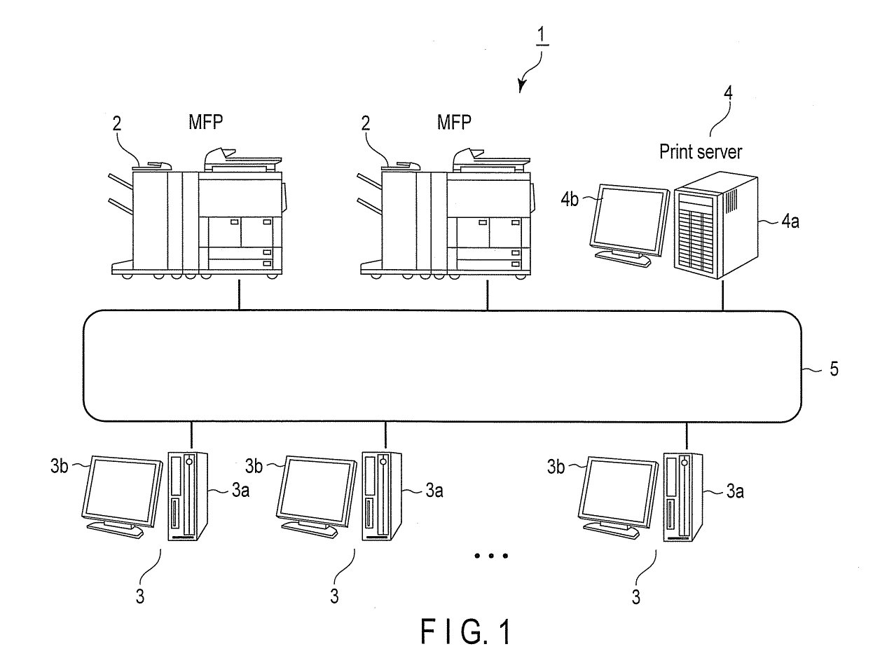

FIG. 1 is an exemplary view showing the configuration of a print system according to a first embodiment. A print system 1 includes at least one MFP 2, client terminals 3, and a print server 4 and they are connected through a communication line 5. The client terminal 3 includes a control unit 3a and a display unit 3b and the print server 4 includes a control unit 4a and a display unit 4b.

The MFP 2 is a digital complex machine, which is a machine having a plurality of functions in a single device, such as a copier, a scanner, a fax machine, and an image data recording device (BOX device).

The client terminal 3 is an information processing terminal, such as a PC belonging to a user and includes a mobile PC and a portable terminal, without being limited to an installation type information processing terminal. The control unit 3a generally controls the operations of the client terminal 3. The display unit 3b displays information communicated with the control unit 3a.

The print server 4 temporarily stores a print job transmitted from the client terminal 3 and transmits the print job to an MFP 2 requesting the print job in accordance with the request from the MFP 2.

The communication line 5 is a passage widely used in communication of information and is not limited to communication using a wire, such as a conductive line or an optical fiber, but includes even radio communication using light, sound waves, and radio waves.

Next, the operation of the print system according to the first embodiment is described. The print system largely has two functions. The first function is a function of registering a print job from the client terminal 3. The second function is a function of designating a print job from the MFP 2 and performing printing.

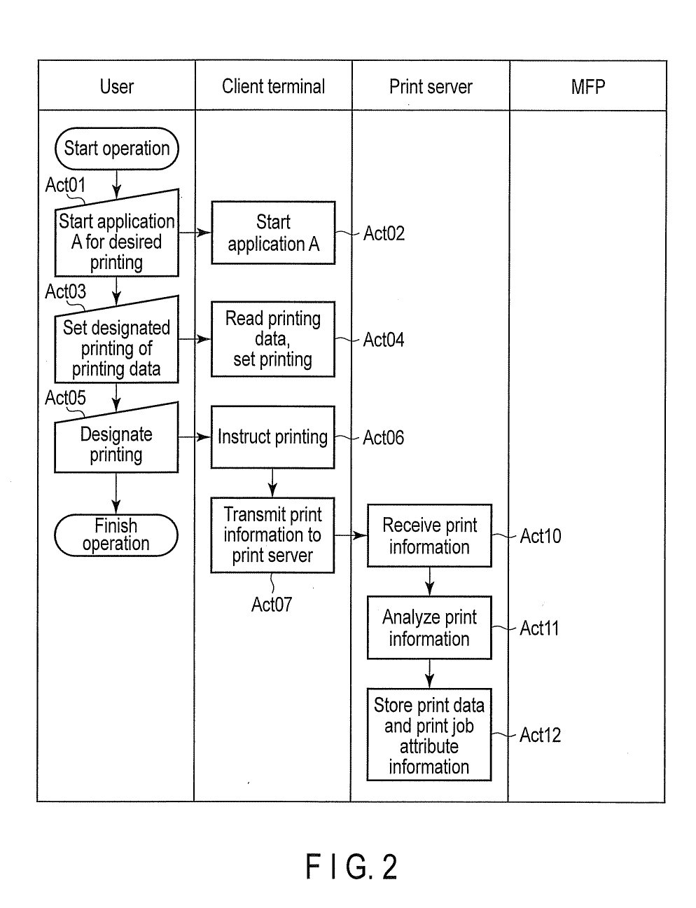

FIG. 2 is an exemplary flowchart showing the order of registering print jobs in the print system according to the first embodiment.

In Act 01, when a user performs an operation for printing, the client terminal 3 starts an application A in Act 02. In Act 03, when the user inputs a setting for printing by designating print data, the application A acquires the setting and creates print information in the client terminal 3 in Act 04.

When the user instructs printing in Act 05, the client terminal 3 starts printing in Act 06. The client terminal 3 transmits the print information to the print server 4 in Act 07. The transmitted print information is the print data and attribute information of the print job. For example, the transmitted print information includes the user name (user ID) designated in the client terminal 3, a print job name, a job type, and a password in addition to print data.

The print server 4 receives the print information in Act 10. The print server 4 analyzes the received print information in Act 11 and associates the print data with the attribute information of the print job and stores the print data and the attribute information of the print job in Act 12.

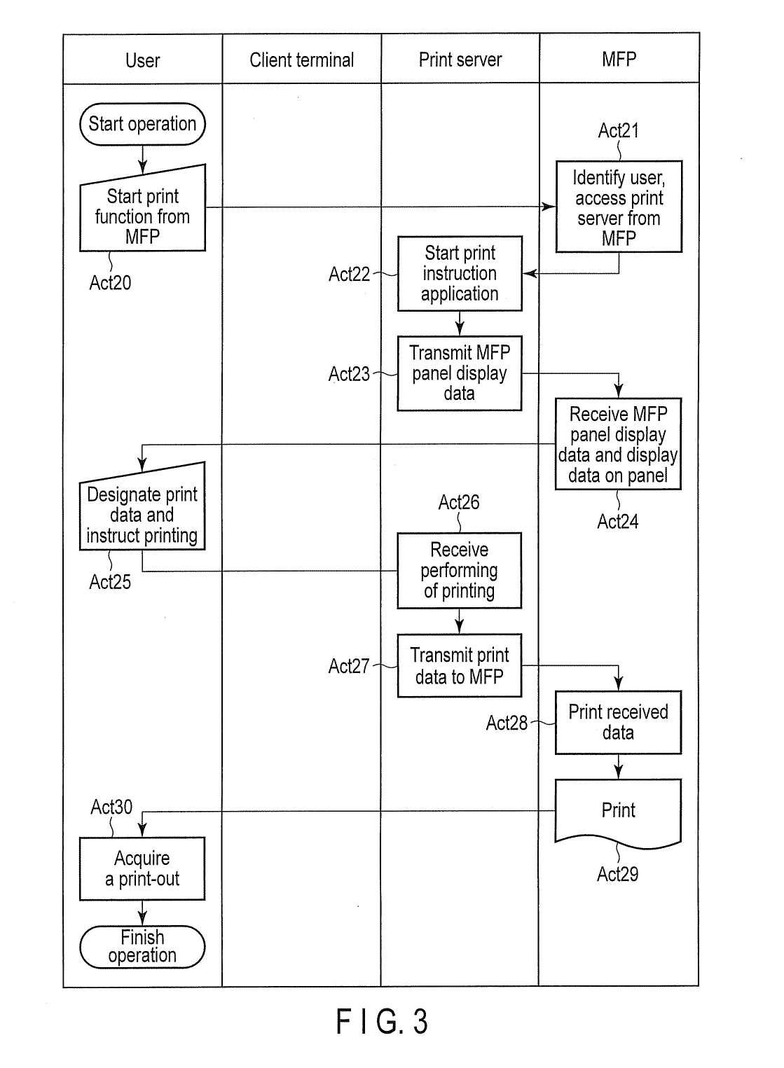

FIG. 3 is an exemplary flowchart showing the order of printing in the print system according to the first embodiment.

The user executes printing by using the MFP 2 after registering the print job to the print server 4. The user starts the printing function of the MFP 2 in Act 20. The MFP 2 authenticates the user on the basis of the user ID or the like input from the user, accesses the print server 4, and requests list information of the print job in Act 21.

The print server 4 starts a printing-instructing application in accordance with the request from the MFP 2 in Act 22. The printing-instructing application extracts the list information of the print job of the authenticated user and transmits the list information to the MFP 2 in Act 23.

The MFP 2 displays the list of the print jobs from the received print information on a print job selection screen (the details are described below) of a control panel in Act 24. The user instructs printing by selecting a desired print job from the displayed list of print jobs in Act 25. The user transmits the information of the designated print job to the print server 4.

The print server 4 receives the designated information in Act 26. The print server 4 transmits the data of the designated print job to the MFP 2 in Act 27.

The MFP 2 receives the print data in Act 28. The MFP 2 performs printing on the basis of the received print data in Act 29. The user acquires the print-out in Act 30.

Next, the operation of changing the document name in the print system according to the first embodiment is described.

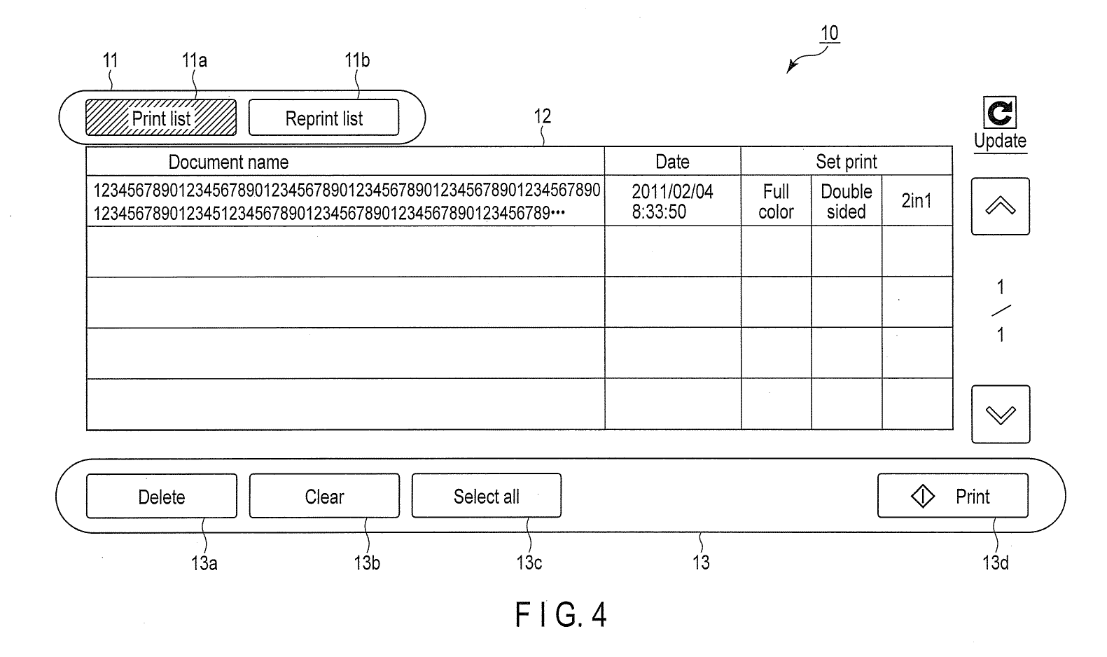

FIG. 4 is an exemplary print job selection screen 10 in the print system according to the first embodiment. The print job selection screen 10 is displayed on the control panel of the MFP 2.

The print job selection screen 10 includes a list selection area 11, a list display area 12, and an operation area 13. A printing list button 11a and a reprinting list button 11b are disposed in the list selection area 11. The list of attributes of the print job of the authenticated user is displayed on the list display area 12. The attributes of the displayed print job include a document name, a date, and print setting data (for example, full color printing, double-sided printing, and 2in1 printing). A delete button 13a, a clear button 13b, a select-all button 13c, and a print button 13d are disposed in the operation area 13.

When the printing list button 11a is operated, the list of the attributes of the print job of the authenticated user, which is not performed yet, is displayed, and when the reprinting list button 11b is operated, the list of attributes of the print job of the authenticated user, which is already being printed, is displayed. Therefore, printing can be performed again.

The print job attributes displayed in the list display area 12 can be selected for each print job unit (one line). The user can select a plurality of print jobs (a plurality of lines). Further, when there is a plurality of print jobs, it is possible to slide the display range for each line by operating a slide bar, such that it is possible to change the display range in a plurality of line units by updating operation.

When the delete button 13a is operated, the selected print job can be deleted. When the clear button 13b is operated, the selected state is cleared and a return is made to the non-selected state. When the select-all button 13c is operated, all of the print jobs displayed in the list display area 12 are selected. When the print button 13d is operated, the MFP 2 starts printing the selected print job.

Because the document names are long, it is not possible to display all of the document names in the print job selection screen 10 shown in FIG. 4. Accordingly, the last data of the document name is not displayed. Data for identifying the job is usually given at the end of the document name. For example, data for identifying the job, such as the “identifier”, the “version” or the “date”, is usually given. As described above, since the data for identifying the job is not displayed in the document name indication column in the print job selection screen 10 shown in FIG. 4, the user may have difficulty in recognizing whether a document is the desired document or not.

In the print system according to the first embodiment, in order to prevent this kind of display, the print server 4 performs a process of changing the document name when the document name of the print job is longer than a predetermined threshold value. That is, the print server 4 extracts the earlier portion and the latter portion of the document name and replaces middle portion with predetermined character strings.

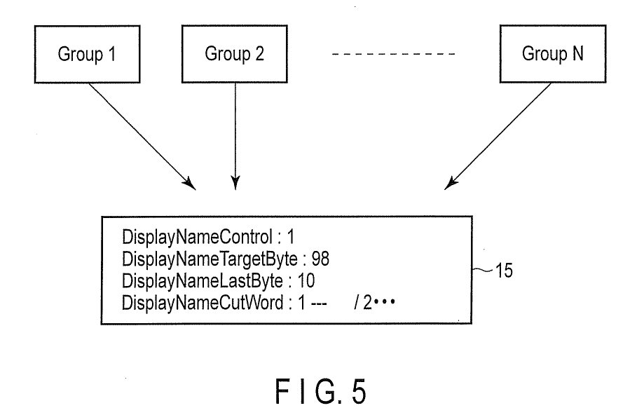

FIG. 5 is an exemplary character string setting file 15 in the print system according to the first embodiment. The character string setting file 15 is set for each group of MFPs and stored in the print server 4. When list information of print jobs is requested from the MF2 (Act 23 in FIG. 3), the print server 4 changes the long document name with reference to the character string setting file 15 of the group to which the MFP 2 belongs.

When referring to the character string setting file 15 shown in FIG. 5, in the entire length of 98 bytes of the long document name, 10 bytes are used for the latter portion and the middle portion is replaced by a shortened phrase of “ . . . ”.

The contents of the orders described in the character string setting file 15 are as follows.

In “Display Name Control”, data of whether to change a long document name (whether to perform display control) is set. The set data becomes 1 when changing is performed, 0 when changing is not performed, and 0 as a default.

In “Display Name Target Byte”, the number of bytes of the document name displayed on the print job selection screen 10 is designated. The default is 98 bytes. The length of the document name that can be displayed on the print job selection screen 10 depends on the type of MFP. Therefore, group division is performed on the basis of the type of MFP.

In “Display Name Last Byte”, how many bytes will be left from the end when the long document name is changed is set. The default is 10 bytes.

In “Display Name Cut Word”, the shortened phrase displayed at the middle portion is set. When the set value is 1, the shortened phrase is “-------”. When the set value is 2, the shortened phrase is “ . . . ”. Further, the default is “ . . . ”.

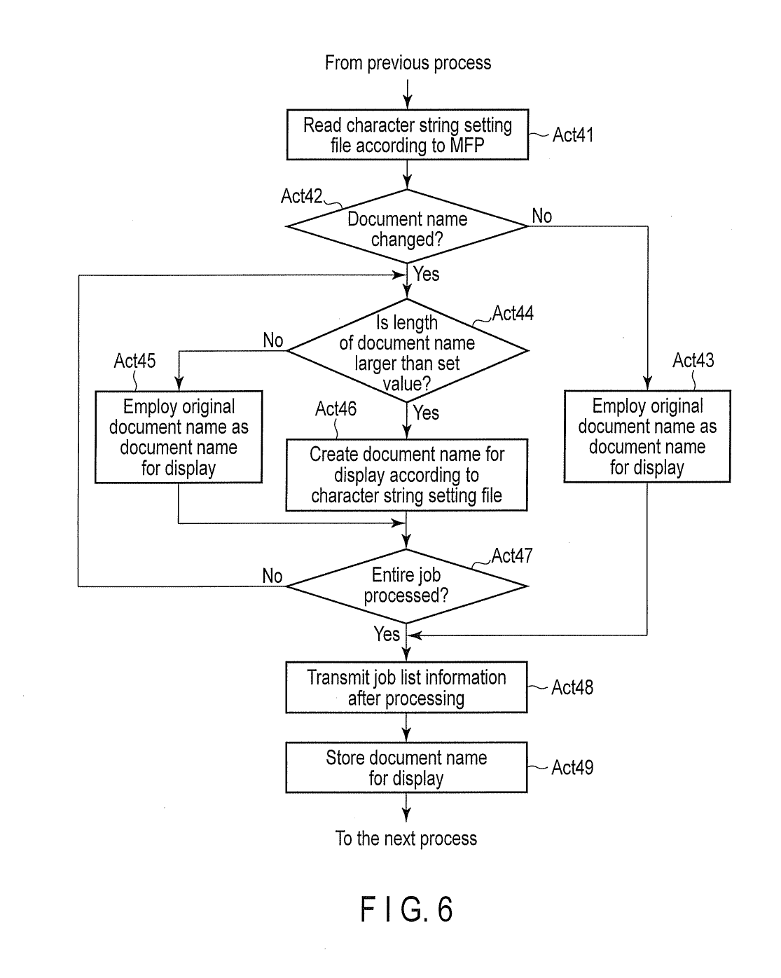

FIG. 6 is an exemplary flowchart showing the order of process changing a long document name in the print system according to the first embodiment. The processing order is performed by the print server 4. The process of Act 23 in FIG. 3 is described in detail in the processing order.

The print server 4 reads the character string setting file 15 corresponding to an MFP 2 that requests a job list in Act 41. The print server 4 determines whether to change the document name from the “Display Name Control” in the character string setting file 15 in Act 42.

When the document name is not changed (NO in Act 42), the original document name is employed as the document name for display in Act 43. Thereafter, the processes from Act 48 are performed.

When the document name is changed (Yes in Act 42), the print server 4 checks whether the length of the document name is longer than the set value of the “Display Name Target Byte” of the character string setting file 15 in Act 44.

When the length of the document name is the set value or less (NO in Act 44), the original document name is employed as the document name for display in Act 45. Thereafter, the process of Act 47 is performed.

When the length of the document name is longer than the set value (Yes in Act 44), the print server 4 creates the document name for display in accordance with the set value of the character string setting file 15 in Act 46.

In Act 47, when there is a job that is not performed yet in the result of checking whether the processes from Act 44 to Act 46 for all the jobs shown in the list are performed (NO in Act 47), the processes from Act 44 are performed.

When the process is performed for all the jobs (Yes in Act 47), the print server 4 transmits the job list information after the process to the MFP 2 in Act 48. The print server 4 associates the document name for display with the job data and stores the relationship in Act 49.

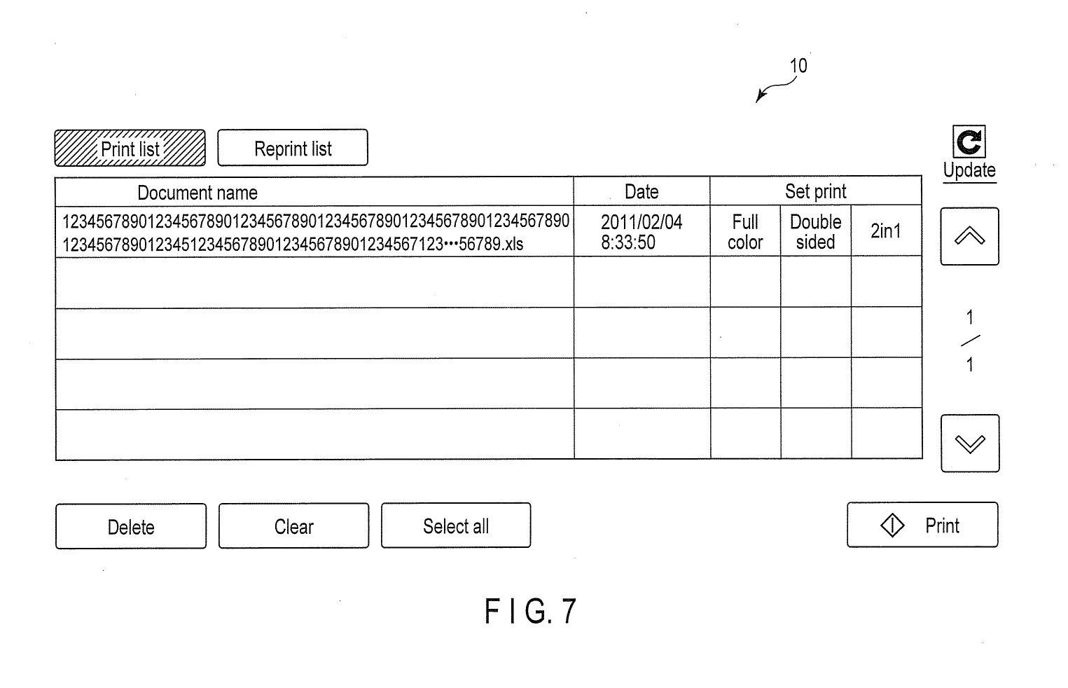

FIG. 7 is an exemplary print job selection screen 10 in the print system according to the first embodiment. The document name is changed into a document name for display and displayed in the print job selection screen 10 shown in FIG. 7. Accordingly, the user can clearly recognize the desired document.

Further, the document name for display created by the processes described above is used to be displayed on the control panel of the MFP 2. Therefore, the original document name created in the client, terminal 3 is stored without being changed. Further, the created document name for display is stored in association with the job data. This is because the document name for display is the information that is necessary to specify the print job selected in the MFP 2.

Further, a manager of the print system records the set value onto the character string setting file 15 through the print server 4. This is because the processes described above influence the entire operation of the print system. However, users other than the manager may input the set value for the character string setting file 15 set for each user, from the MFP 2 in order to temporarily use the document name for display. In this case, the print server 4 further creates the document name for display on the basis of the character string setting file 15 corresponding to the user ID.

### Second Embodiment

The second embodiment is different in the method of changing the character string of a document name from the first embodiment. The same components as those in the first embodiment are indicated by the same reference numerals and the detailed description is not provided.

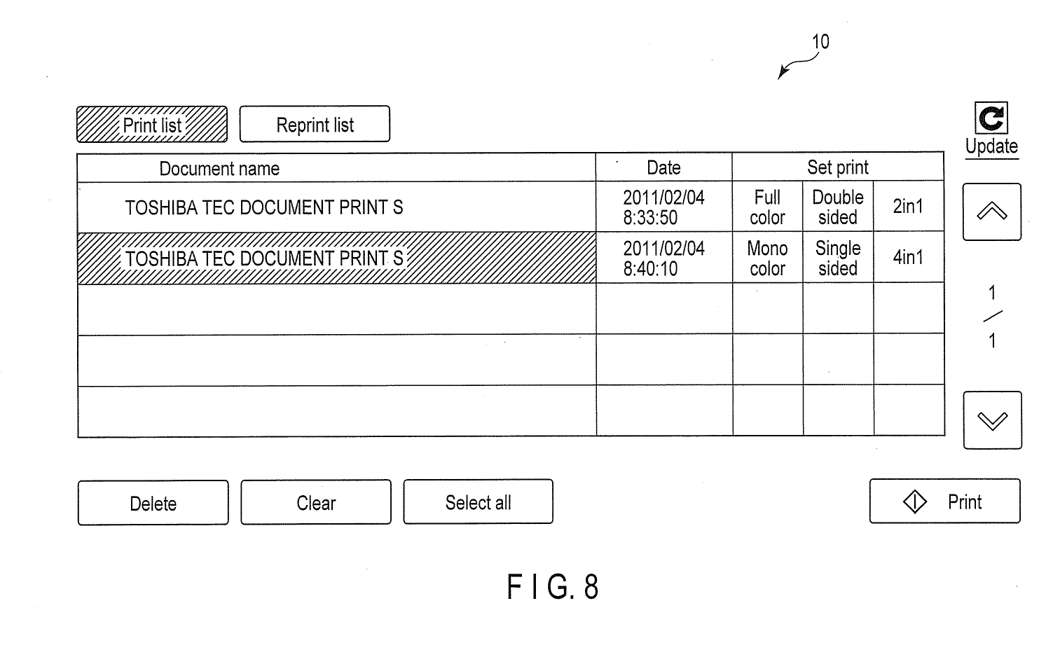

FIG. 8 is an exemplary print job selection screen 10 in a print system according to the second embodiment. The entire document name cannot be displayed in the print job selection screen 10 shown in FIG. 8 because the document name is long. Accordingly, the final data of the document name is not displayed. Although “TEST Specification” and “TEST Certificate” are described at the end of the document name, a user has difficulty in recognizing whether it is the desired document, because the characters are not displayed.

In the print system according to the second embodiment, in order to prevent this kind of display, when there is a character string in the document name which agrees with pre-registered character strings, the print server 4 replaces the character string with the set character string.

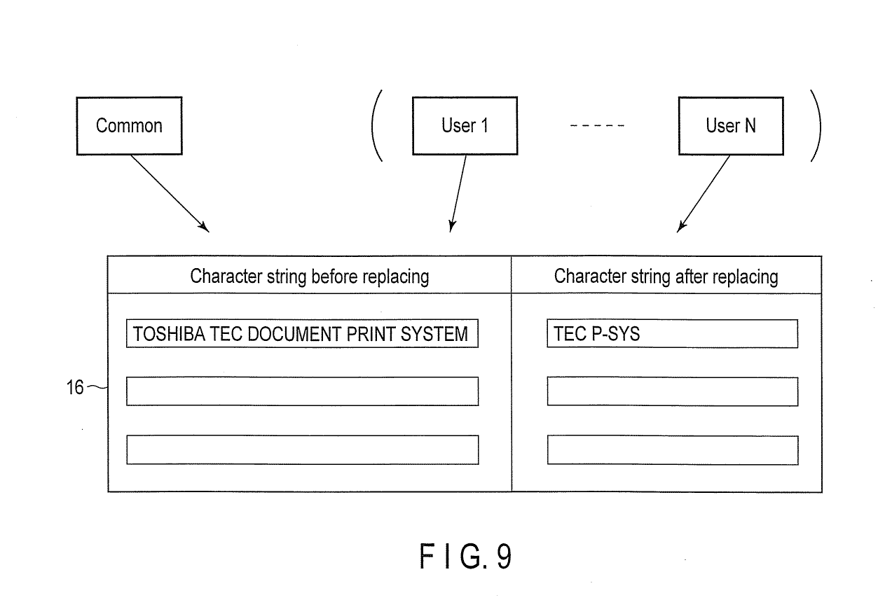

FIG. 9 is an exemplary character string replace setting file 16 in the print system according to the second embodiment. Common replacement in the print system is set in the character string replace setting file 16. The print server 4 changes the document name with reference to the common character string replace setting file 16, when receiving and analyzing the information of a print job from the client terminal 3 (Act 11 in FIG. 2).

The character string replace setting file 16 shown in FIG. 9 is set to replace a character string of “TOSHIBA TEC DOCUMENT PRINT SYSTEM” with “TEC P-SYS”. Further, it is possible to set replace character strings for a plurality of character strings in the character string replace setting file 16.

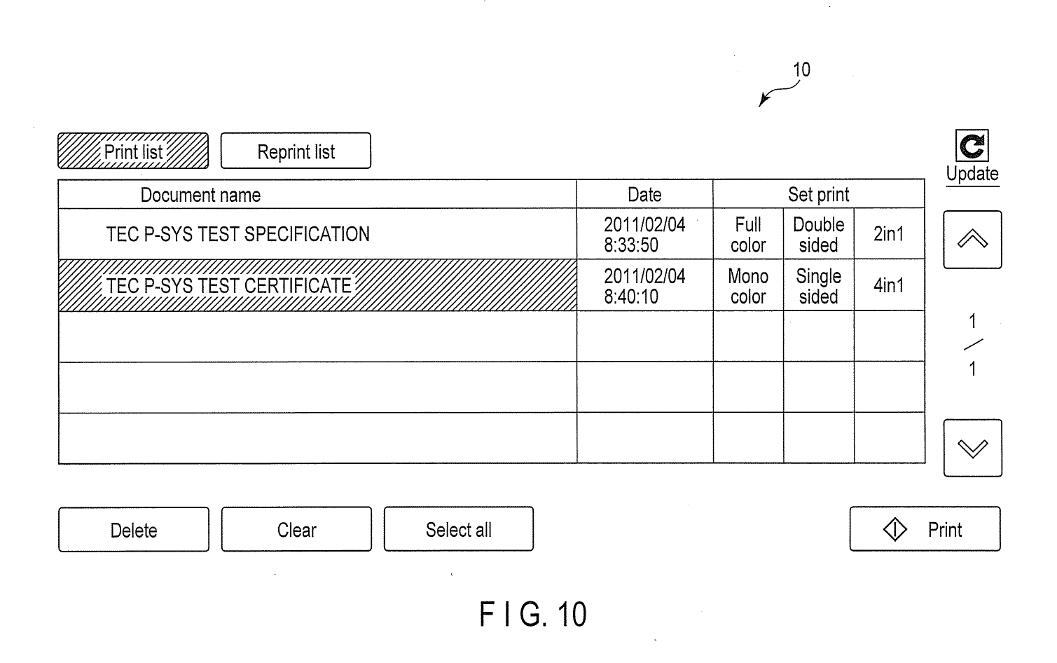

FIG. 10 is an exemplary printing job selection screen 10 in the print system according to the second embodiment. The document name shown in the print job selection screen 10 shown in FIG. 10 is a replaced document name. Therefore, the “TEST Specification” and “TEST Certificate” that are not displayed in the print job selection screen 10 shown in FIG. 9 are displayed as document names. As a result, a user can clearly recognize the desired document.

Further, a manager of the print system records the set value onto the character string replace setting file 16 through the print server 4. This is because the processes described above influence the entire operation of the print system. Further, the reason for employing the character string replacing the character string of the document name as a new document name is to create a standardized document name according to a predetermined rule.

### Variation of Second Embodiment

As a variation of the second embodiment, it may be possible to provide the character string replace setting file 16 for each user and allow the user to write a set value onto the character string replace setting file 16. This is because the character strings that are frequently used by the users may be different, such that it is required to create standardized document name for each user. In this case, the print server 4 changes the document name on the basis of the character string replace setting file 16 according to the user ID.

Further, it may be possible to provide a common character string replace setting file 16 for each user such that the users change the document names with reference to the file. In this case, the print server 4 changes the document name with reference to the common character string replace setting file 16 and further changes the document name on the basis of the character string replace setting file 16 corresponding to the user ID.

### Another Embodiment

It is possible to implement both of the first embodiment and the second embodiment in another embodiment. The same components as those in the first and second embodiments are indicated by the same reference numerals and detailed description thereof is not provided.

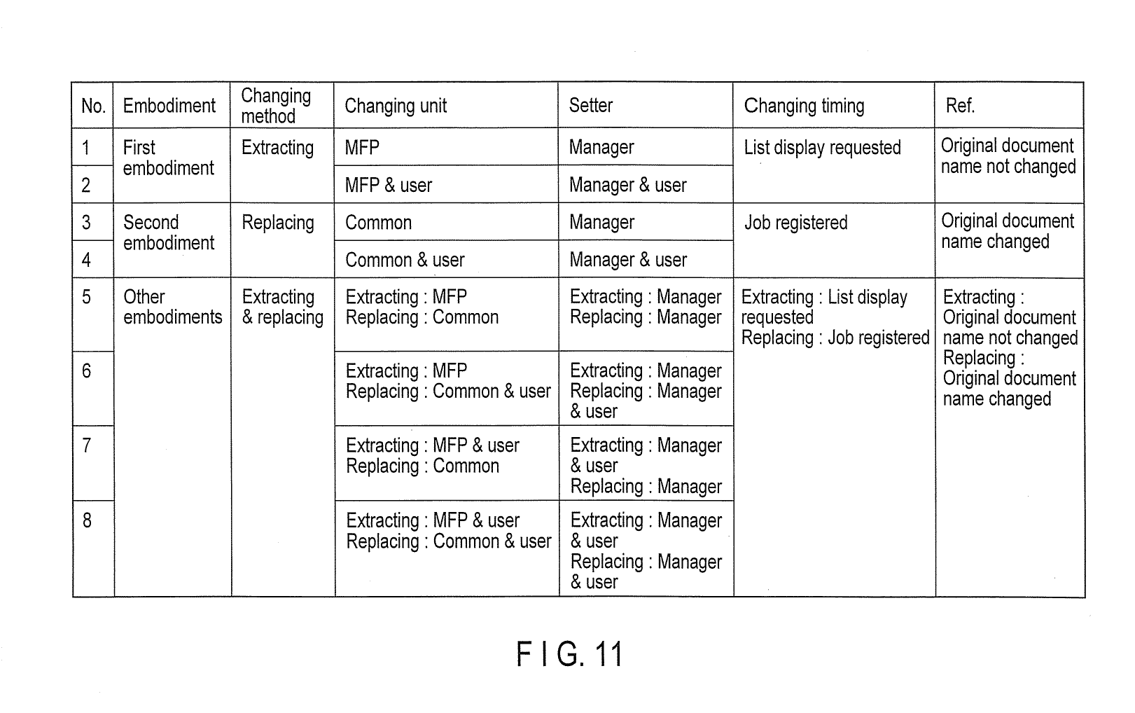

FIG. 11 is an exemplary list showing the functions of a print system according to the other embodiment.

The numbers 1 and 2 of the list shown in FIG. 11 indicate the functions of the print system according to the first embodiment and the numbers 3 and 4 indicate the functions of the print system according to the second embodiment. Further, the numbers 5 to 8 indicate the functions of the print system according to the other embodiment.

According to the embodiments described above, a user can precisely and easily select a desired print job and it is possible to reduce waste due to selecting a job that ought not to be performed by mistake.

Further, the functions described in the embodiments described above may be implemented by hardware or may be implemented by reading programs where the functions are written by using software with a computer. Further, the functions may be implemented by selecting any one of software and hardware. Further, it may be possible to implement the functions by reading programs stored in a recording medium (not shown) with a computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A print server that is connected with at least one printing device and client terminal through a communication line, the print server comprising:
an information acquiring-storing unit configured to acquire and stores print data and attribute information of a print job from the client terminal;
an information changing unit configured to shorten a portion of character strings of the attribute information of the print job on the basis of a preset changing rule; and
an information transmitting unit configured to transmit the attribute information of the print job including some shortened information to the printing device in accordance with a request from the printing device.

2. The server according to claim 1,
wherein the information changing unit shortens the portion of the character string of the attribute information of the print job when receiving a request from the printing device.

3. The server according to claim 2,
wherein the changing rule is a common rule and is set by a manager of the print system.

4. The server according to claim 3,
wherein the changing rule is provided for each printing device.

5. The server according to claim 4,
wherein the changing rule provided for each printing device is set by a user of the printing device.

6. The server according to claim 2,
wherein a portion of the attribute information of the job is a document name and
the information changing unit employs the character string having a predetermined length at the end of the document name and replaces the middle portion with the shortened phrase such that the document name is implemented by a character string having a predetermined length.

7. The server according to claim 1,
wherein the information changing unit shortens a portion of the character string of the attribute information of the print job when acquiring the attribute information of the print job from the client terminal.

8. The server according to claim 7,
wherein the changing rule is a common rule and is set by a manager of the print system.

9. The server according to claim 8,
wherein the changing rule is further provided for each user of the printing device.

10. The server according to claim 9,
wherein the changing rule provided for each user is set by the user.

11. The server according to claim 7,
wherein a portion of the attribute information of the print job is a document name and the information changing unit replaces a predetermined character string included in the document name with a set character string.

12. A control method of a print server that is connected with at least one printing device and client terminal through a communication line, the method comprising:
acquiring and storing print data and attribute information of a print job from the client terminal;
shortening a portion of a character string of the attribute information of the print job on the basis of a preset changing rule; and
transmitting the attribute information of the print job including some shortened information in accordance with a request from the printing device to the printing device.

13. The method according to claim 12,
wherein the shortening comprises shortening a portion of the character strings of attribute information of the print job when there is a request from the printing device.

14. The method according to claim 13,
wherein a portion of the attribute information of the job is a document name and
the shortening comprises employing the character string having a predetermined length at the end of the document name and replacing the middle portion with the shortened phrase in a manner that the document name is implemented by a character string having a predetermined length.

15. The method according to claim 12,
wherein the shortening comprises shortening a portion of the character string of the attribute information of the print job when acquiring the attribute information of the print job from the client terminal.

16. The method according to claim 15,
wherein a portion of the attribute information of the print job is a document name and
the shortening comprises replacing a predetermined character string included in the document name with a set character string.

17. A print system comprising: at least one printing device, client terminal, and print server that are connected to a communication line,
wherein the client terminal creates print data and attribute information of a print job and transmits the print data and the attribute information to the print server,
the print server
acquires and stores the print data and attribute information of a print job from the client terminal;
shortens a portion of a character string of the attribute information of the print job on the basis of a preset changing rule; and
transmits the attribute information of the print job including some shortened information in accordance with a request from the printing device to the printing device, and
the printing device requests list information of the print job stored in the print server to the print server and displays the attribute information of the print job transmitted in accordance with the request.

18. The system according to claim 17,
wherein the print server shortens a portion of the character strings of attribute information of the print job when receiving a request from the printing device.

19. The system according to claim 17,
wherein the print server shortens a portion of the character string of the attribute information of the print job when acquiring the attribute information of the print job from the client terminal.
